(19) United States
(12) Patent Application Publication
(10) Pub. No.: US 2011/0276400 A1
(43) Pub. Date: Nov. 10, 2011

(54) Online Advertisement Storage and Active Management

(75) Inventors: Scott Kurnit, New York, NY (US); Louis J. Paglia, JR., Summit, NJ (US); Scott Germaise, Stamford, CT (US); Ron McCoy, Atlanta, GA (US); Steven Nieker, Seattle, WA (US); Martin Remy, Highlands Ranch, CO (US)

(73) Assignee: AdKeeper Inc., New York, NY (US)

(21) Appl. No.: 13/076,248

(22) Filed: Mar. 30, 2011

Related U.S. Application Data
(60) Provisional application No. 61/319,862, filed on Mar. 31, 2010.
(60) Provisional application No. 61/373,428, filed on Aug. 13, 2010.

(51) Int. Cl. G06Q 30/00

(52) U.S. Cl. 705/14.55

(57) ABSTRACT

A system and a method are disclosed for techniques and processes for stored online content, e.g., digital advertisement objects in a personally controlled repository. The content, e.g., digital advertisement objects, may be enhanced with additional metadata, extended upon by user generated and/or collaborated metadata, as well as the communication used by both the originating user storing the content, e.g., digital advertisement as well as those to whom said user may share the advertising objects with, and the advertiser, publisher and distributor of the content, e.g., digital advertisement. The systems and methods described herein allow for the control and management of distributed advertisements within a controlled repository.

### CROSS-REFERENCE TO RELATED APPLICATIONS

This application claims a benefit of, and priority under 35 U.S.C. §119(e) to, U.S. Provisional Patent Application No. 61/319,862, filed on Mar. 31, 2010, entitled “CAPTURING DIGITAL ADVERTISING ELEMENTS AND STORING OF DISTRIBUTED OBJECTS” which is incorporated by reference in its entirety. The application also claims a benefit of, and priority under 35 U.S.C. §119(e) to, U.S. Provisional Patent Application No. 61/373,428, filed on Aug. 13, 2010, entitled “ONLINE ADVERTISEMENT STORAGE AND ACTIVE MANAGEMENT” which is also incorporated by reference in its entirety.

### BACKGROUND

Digital and Internet advertising take on a variety of forms. Among the most prevalent are display advertisements, or banner advertisements (“banners” or “banner ads”). Banner ads exist in a variety of Internet industry de facto and explicit standards as expressed by various trade organizations. Banner ads began their display history as simple static images, placed on pages through a variety of means. The means of placement upon an Internet page, (or an electronic mail or other delivery mechanism), may be via making them an inherent part of the technical design of a page, requiring manual effort to change. A digital advertisement may be placed based on a variety of ad server systems, which place ads dynamically based on a variety of criteria. As banner ads have evolved, they have taken on additional capabilities commonly referred to as “rich media” (or “rich media ads”). Such rich media ads are usually defined by having a variety of interactive elements.

Existing digital and Internet advertising systems face a variety of challenges. For example, advertising on the Internet is dynamic and forces the user to follow through immediately on an ad, usually at a time when it is displayed to the user, not at a time convenient for the user. This frustrates users, and interrupts the user experience thereby lowering the overall effectiveness of the advertisement both for the advertiser and the user.

### BRIEF DESCRIPTION OF DRAWINGS

The disclosed embodiments have other advantages and features, which will be more readily apparent from the detailed description, the appended claims, and the accompanying figures (or drawings). A brief introduction of the figures is below.

Figure (FIG.) 1 illustrates an example computer system for enhanced online advertisement interaction, storage and active management according to one embodiment.

FIG. 2 illustrates an example embodiment of a user, advertiser, publisher and/or the distributor adding metadata to extend and enhance an advertisement object.

FIG. 3 illustrates an example embodiment of a user and/or group of users collaborating, discussing and/or commenting on an advertisement object.

FIG. 4 illustrates an example embodiment of a user sharing an advertisement object in a semi-private and/or public manner.

FIG. 5 illustrates an example embodiment of a textual representation of a graphical depiction of an advertisement object.

FIG. 6 illustrates an example embodiment of organizing and sorting of an advertisement object.

FIG. 7 illustrates an example embodiment of components of a computer that is able to read instructions from a machine-readable medium and execute them in a processor (or controller).

FIG. 8 illustrates one embodiment of an example communications process of the attribute (expiry) of an advertisement object and the interactions between a computer system, a digital media user, advertiser, publisher and/or the distributor.

FIG. 9 illustrates one embodiment of a communications process between a computer system, a digital media user, advertiser, publisher and/or distributor based upon actions and events that trigger signals.

### DETAILED DESCRIPTION

The Figures (FIGS.) and the following description relate to preferred embodiments by way of illustration only. It should be noted that from the following discussion, alternative embodiments of the structures and methods disclosed herein would be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles also described herein.

### Configuration Overview

One embodiment of a disclosed system, method and computer readable storage medium includes techniques and processes by which an online digital object, e.g., an online advertisement object, may be saved by an Internet user into a personally controlled repository. The online advertisement display, storage and management are enhanced with additional metadata, and used by both the originating user saving the advertisement as well as those with whom that user may share the advertising objects. The disclosed configurations allow both users and advertisers to maintain an ongoing presence of digital advertisement objects, which would otherwise be lost to a momentary viewing or usage only on a web page. The configuration also includes a communication channel between both the users and the advertisers that provides a mechanism for information exchange between the parties.

A user, in one embodiment, may be represented by a consumer, an advertiser, a publisher and/or a distributor. The notion of a user can and may be defined by a specific role, and as such a user can in fact be put into a generic sense. For the purposes of describing one example embodiment, a user is given a specific role in which the user is playing and is described with respect to the role the user is given.

One embodiment addresses the above-described problems by providing a method for the management, extension, and enhancement of captured digital advertising elements, including graphics and multimedia objects, and placement of such saved objects in a repository in an identified, reusable, and extensible manner. The method encapsulates user identity, advertisement asset (“ad asset”), and sources related to the digital advertising elements within a data envelope and communicates the data envelope to a repository for later use. Embodiments of the disclosed configurations encompass this described communications method, the repository, primary and multiple secondary means for user retrieval of the advertisement assets. Additionally, one embodiment of the disclosed configurations provides a management system for token management of the ad assets.

Example embodiments disclosed comprise multiple banner advertising configurations for capture, reuse, extension, enhancement and management methods, which can be applied to as an additional layer to existing banner advertising, and asset management technologies. In one embodiment, by creating a container for the storage and management of distributed advertisements, a system (and method and computer readable medium) are designed to facilitate the ability of extending and enhancing distributed ads. Further, a process of adding metadata directly to the advertisements greatly improves the value of the advertisement, as does the ability to share the advertisement which allows users to take action in a much more collaborative environment.

In another embodiment, advertisers, publishers and distributors may use a communication model to communicate with the consumers of their distributed advertisements. A storage and processing system (and method) as disclosed and described herein allows for this communication process to take place in a bi-directional medium. Further, the advertisers, publishers and distributors beneficially receive communication relating to their campaigns and communicate with the consumers of the distributed ads. Likewise, consumers may desire to extend and enhance the digital content, e.g., distributed ads. A system (and method and computer readable medium) as disclosed and further described herein, allows for consumers to manage the distributed ads, as well as provide a feedback loop in a more enriched environment.

### Online Advertisement System Configuration

Referring now to Figure (FIG.) 1, it describes a high level overview of an example computer system for enhanced online advertisement interaction, storage and active management according to one embodiment. This figure also shows some of the basic flow within the computer system, advertisement objects and interactions of the advertising objects and various entity participants. In the embodiment illustrated in FIG. 1, the computer system comprises an advertisement object repository 100, an advertisement 102, an advertising agent 115, a digital media user 110, an advertiser interface 117 and a consumer interface 112. The advertising agent 115 communicates with the advertisement object repository 100 via the advertiser interface 117. The digital media user 110 communicates with the advertisement object repository 100 via the consumer interface 112. The advertisement object repository 100 saves, stores and archives advertisements 102 on behalf of advertising agents 115 and/or digital media users of advertisements.

An advertisement 102 comprises an advertisement object including, but not limited to, banner, rich media, video, gaming, mobile, geo-located and/or user-generated advertisements. An advertising agent 115 comprises any entity that sells, transports and/or places advertisements for themselves or on behalf of an advertiser. An advertising agent can comprise, but not limited to, a direct advertiser, advertising agency, advertising network representing one or more advertisers and/or a publisher. An advertiser publisher comprises any entity that creates, promotes, distributes and/or redistributes content, and/or promotes advertisements to users, thereby also being considered an advertising agent. A publisher can also include a publisher platform provider that enables the creation and promotion of content from others.

An advertisement object repository 100 comprises an entity that saves, stores and archives advertisements on behalf of advertising agents 115 and/or users of advertisements. An advertisement object stored within the advertisement object repository 100 comprises an identity (ID) token which is a unique identifier representing a specific advertisement object that maintains its uniqueness within the scope of such identifier associated with its respective advertising agent or content provider. An encoded advertisement comprises an advertisement that has been tagged with information from the advertisement object repository 100, including but not limited to its unique object identification (ID) tokens.

A digital media user 110 can be any user that encounters, interacts or uses an encoded advertisement in the context of a digital media object. A digital media object 125 comprises any container or object, including but not limited to a web page, mobile application and/or game that includes an advertisement. Saving 160 an advertisement object comprises an act by any digital media user 110 upon an encoded advertisement that initiates a transaction to save an advertisement to the advertisement object repository 100. Uploading an advertisement object comprises an act by any advertiser that initiates a transaction to insert and/or upload an advertisement to the advertisement object repository 100.

An advertising agent 115 establishes a relationship with the advertisement object repository 100 to obtain unique object ID tokens, comprising elements for creating encoded advertisements. An advertising agent 115 uploads and/or inserts 165 the encoded advertisement with other advertising agent 115, directly with publisher 115, or within the advertising object repository 100 for subsequent distribution. A digital media user 110 views a digital media object 125 that serves the encoded advertisement either directly or in cooperation with advertising agent 115. Upon interacting with the encoded advertisement, the digital media user 110 has an opportunity to save 160 the advertisement object within the advertisement object repository 100.

The advertisement object repository 100 comprises an advertisement object repository database 120, an advertisement object repository account database 172 and an advertisement object save transaction database 175. An advertisement object repository database 120 comprises a storage system that enables collection, retrieval, and modification of data and metadata regarding individual advertisement objects. In order for an advertising agent 115 to participate (e.g., associate extensible metadata to an advertisement object), the advertising agent must establish an account with the advertisement object repository 100. The account for the advertising agent 115 is represented by a unique advertising agent account and respective set of advertising identifications (IDs) 170.

In order for a digital media user 110 to participate (e.g., associate extensible user generated metadata to an advertisement object), the digital media user 110 in one embodiment may have an account with the advertisement object repository 100. The account for the digital media user 110 is represented by a unique user account and respective set of advertising IDs 171.

An advertiser interface 117 comprises a system represented by a graphical or programmatic interface allowing advertising agents 115 to manage all aspects of their relationship with the advertisement object repository 100, including but not limited to advertising agent information, campaigns and statistics. A consumer interface 112 allows digital media users 110 to manage all aspects of their saved advertisement objects within the advertisement object repository 100, including but not limited to information, statistics, and metadata.

Each advertising agent 115 is associated with an advertising agent account ID 170, which comprises a unique identifier representing a specific advertising agent and/or user and establishes a unique ID space that allows for unique object ID tokens. Each digital media user 110 is associated with a user account ID 171, which identifies the user as a distinct user within the consumer interface 112. The advertisement object repository account database 172 comprises a storage system that allows collection, retrieval, and modification of data and metadata regarding individual advertising agent and/or user accounts.

In addition, an advertisement identification (ID) 173 comprises a unique identifier representing a specific advertisement that maintains its uniqueness within the scope of such identifiers that are associated with its respective advertising agent or content provider. An advertisement object save transaction database 175 comprises a storage system that enables the collection, retrieval, and modification of data and metadata regarding individual advertisement object save transactions (including, but not limited, to the advertisement ID and the user ID).

An advertisement object repository API 174 comprises a programming interface to read, add, delete and modify data within the advertisement object repository database 100. An advertisement management interface 176 comprises a system represented by a graphical or programmatic interface allowing advertising agents 115 to manage all aspects of individual advertisements associated with their accounts including but not limited to establishing advertisement object ID tokens and managing data elements associated with those advertisements.

Other embodiments may also include an advertisement categorization repository, a taxonomy repository (not shown in FIG. 1) and other repositories in the system for storing additional information for online advertisements management purpose. The advertisements categorization and taxonomy information can be generated from the lexical, spatial, semantic, geographic information observed from user advertisement selections and interactions with advertisements. In one embodiment, the online advertisements management system encodes a user selected advertisement with the information retrieved from the categorization and taxonomy repositories. The online advertisements management system can use the information stored in the advertisement categorization and taxonomy repositories to search filter, constrain, or otherwise identify advertisements that are more suitable to a user.

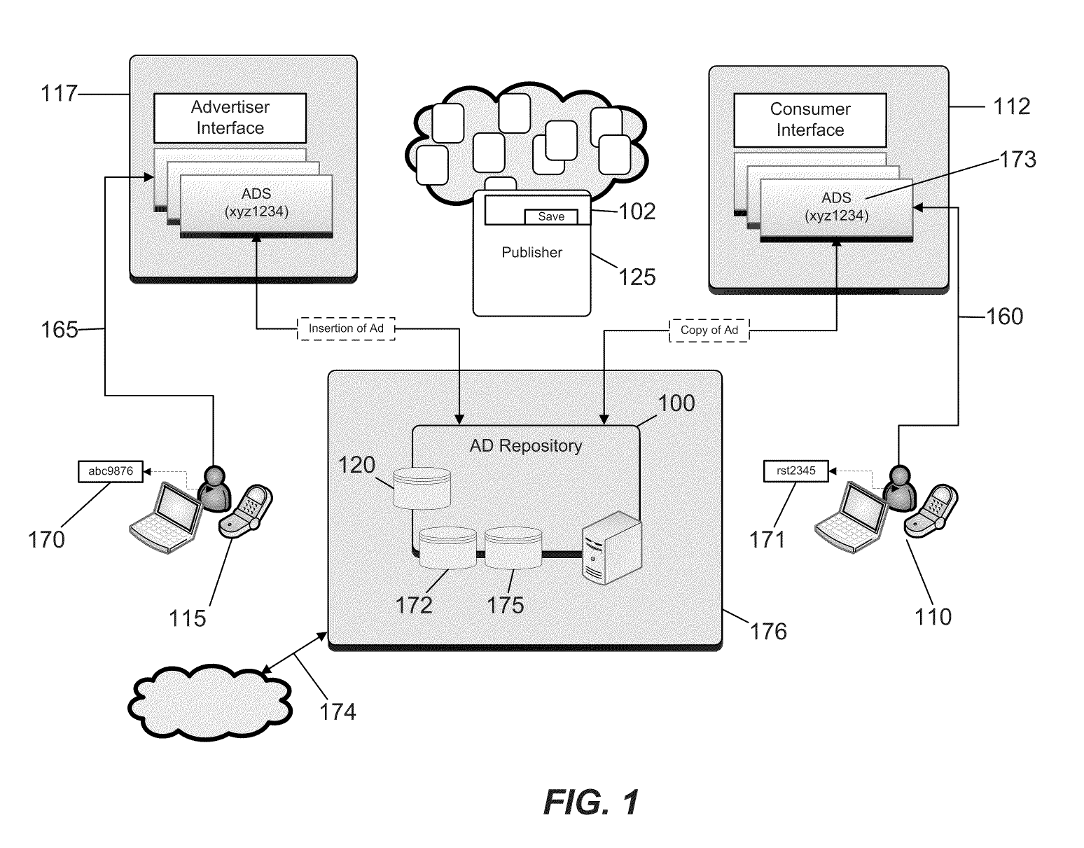

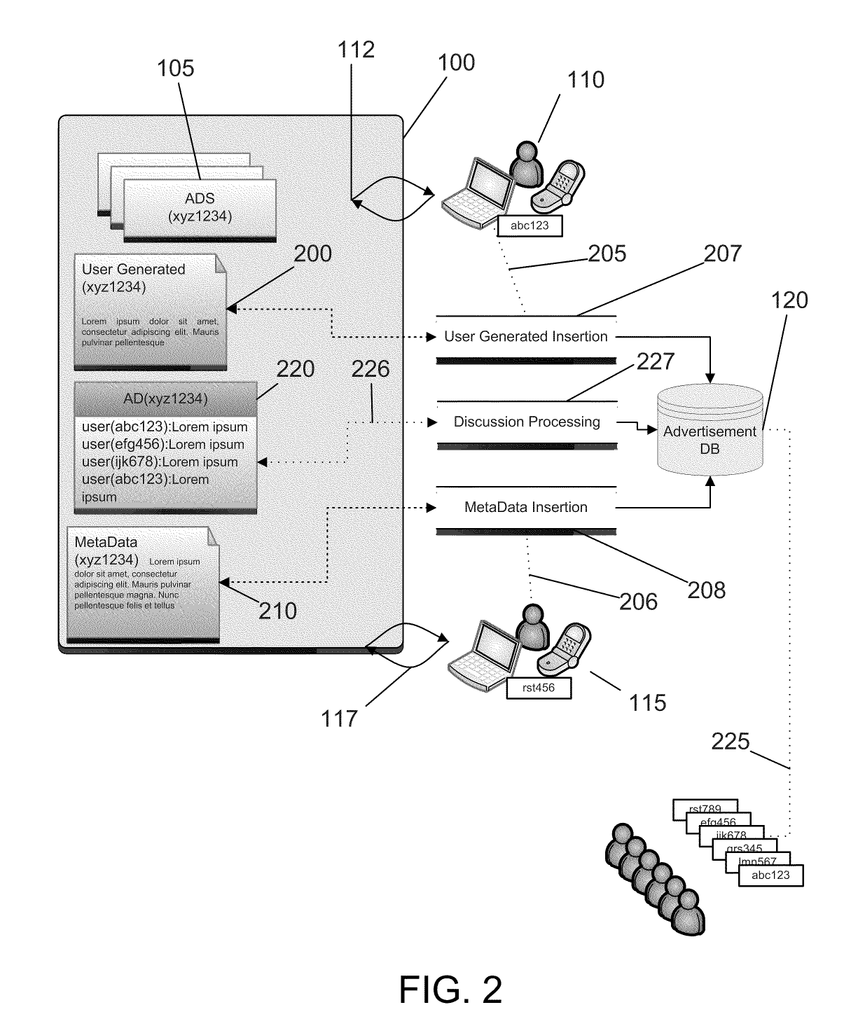

Turning now to FIG. 2, it illustrates one example embodiment of interaction between an advertisement object, an advertising agent 115, a digital media user 110, and advertisement information (e.g., metadata, user generated content, and assets) within an advertisement object repository 100. The interaction depicted here is just an example of a digital media user 110 adding and/or extending user generated metadata and attaching that metadata to a distributed advertisement as well as a user and/or group of users participating within a discussion associated with a distributed advertisement. The ability for an advertising agent 115 to also attach metadata and/or to participate within a discussion around and attached to a distributed advertisement in order to enhance or extend such distributed ad is also demonstrated.

An advertising agent 115 first establishes a relationship with the advertisement object repository 100. The advertising agent 115 uploads and/or inserts 206 metadata (e.g., description of an advertisement) and additional assets 210 (e.g., thumbnail images and/or audio clips of a video advertisement) through the advertiser interface 117 associated with an encoded advertisement 105 within the advertising object repository 100 for enhancement. This metadata is inserted and/or updated 208 into the advertisement object repository database 120. Upon interacting with the encoded advertisement 105, the advertising agent 115 has an opportunity to relate further information 210 and associate that information 210 with the encoded advertisement 105.

The digital media user 110 views the encoded advertisement 105 and uploads and/or inserts 205 metadata and additional assets 200 through the consumer interface 112 associated with the encoded advertisement 105 within the advertising object repository 100 for enhancement. This metadata is then inserted and/or updated 207 into the advertisement object repository database 120. Upon interacting with the encoded advertisement 105, the digital media user 110 has an opportunity to relate further information 200 and associate that information 200 with the encoded advertisement 105.

The advertising agent 115 establishes a relationship with the advertisement object repository 100. The advertising agent 115 uploads and/or inserts 226 content 220 through the advertiser interface 117 associated with the encoded advertisement 105 within the advertising object repository 100 for discussion. The content 220 is then inserted and/or updated 227 into the advertisement object repository database 120. Upon interacting with the encoded advertisement 105, the advertising agent 115 has an opportunity to participate in further discussion 225 and the information 220 is to be inserted and/or updated 227 into the advertisement object repository database 120 and associated to an encoded advertisement 105.

The digital media user 110 views the encoded advertisement object 105 and uploads and/or inserts 226 content 220 through the consumer interface 112 associated with the encoded advertisement 105 within the advertising object repository 100 for discussion. The content 220 is then inserted and/or updated 227 into the advertisement object repository database 120. Upon interacting with the encoded advertisement 105, the digital media user 110 has an opportunity to participate in further discussion 225 and the information 220 is inserted/updated 227 into the advertisement object repository database 120 and associated with the encoded advertisement 105.

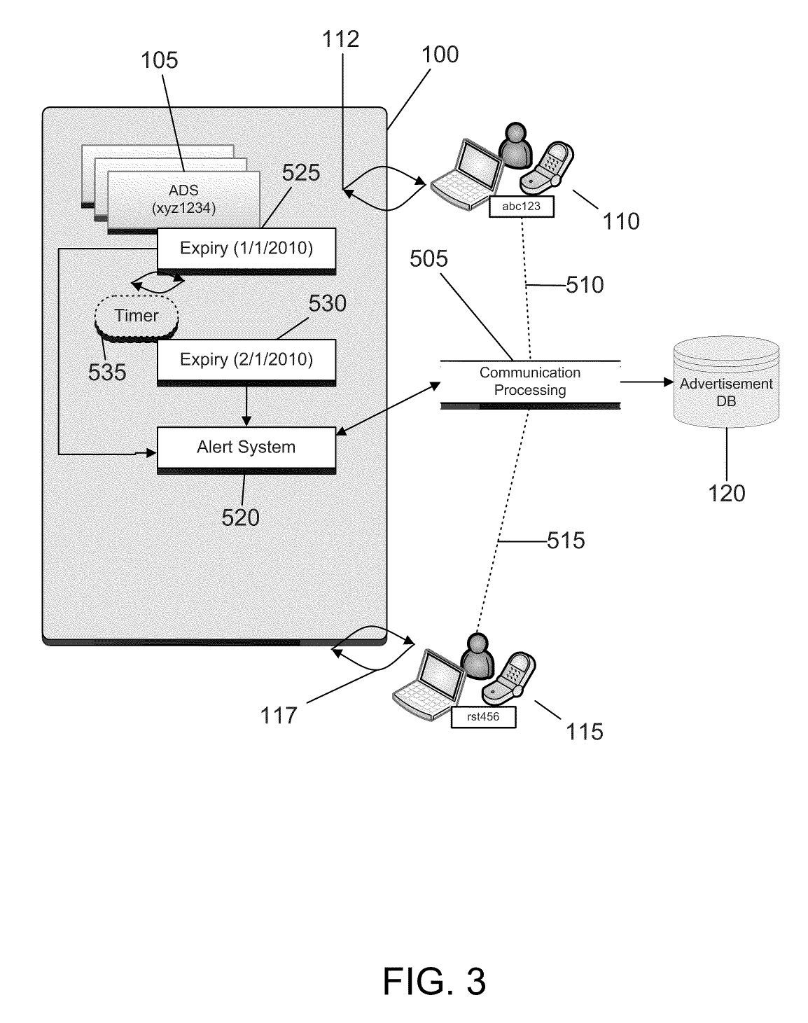

Next, FIG. 3 illustrates one embodiment of interaction between the encoded advertisement object 105, the advertising agent 115, the use of information in and around the distributed advertisement within the advertisement object repository database 120. The interaction depicted here is an example of a user and/or advertising agent participating within a communications channel based upon one or more distributed advertisements. Some of the interactions (e.g., insert associated attributes) are referenced with FIG. 2 described above.

The advertising agent 115 first establishes a relationship with the advertisement object repository 100. The advertising agent 115 uploads and/or inserts 226 associated attributes 220 through the advertiser interface 117 associated with the encoded advertisement 105 within the advertising object repository 100 for extension. The attributes 220 can include, for example, an expiry date 530 (e.g., time and date for a campaign, and/or other associated attributes) that are then inserted and/or updated 227 into the advertisement object repository database 120. The digital media user 110 views an encoded advertisement object 105 and decides to be alerted 520 to the expiration of the encoded advertisement abject 105. The system processes this alert 520 and creates an ongoing method 535 based upon the digital media user 110 interval that has been set. Upon the threshold being met, the system sends an alert 520 (e.g., an email or a text message) to the digital media user 110 and/or the advertising agent 115 that the threshold has been met. Examples of the threshold include predefined expiration date (e.g., time and date for an advertisement campaign), attributes of user behavior (e.g., a wireless user leaving a particular geo location targeted by an advertisement campaign) and third-party attributes (e.g., external events triggering updates of an advertisement campaign). The digital media user 110 has an opportunity to act upon that attribute 525, and the advertising agent 115 has an opportunity to engage the digital media user 110 and modify the attribute 525 (e.g., extended the expiry date) thus creating a future event associated with the encoded advertisement object 105.

The digital media user 110 communicates with the advertising agent 115 associated with the digital media user 110 in receiving more information or other associated encoded advertisement object(s) 105 that may be similar or related to an encoded advertisement object 105 that the digital media user 110 has already saved within the advertisement object repository database 120. This creates a bi-directional interactive communications channel between both the digital media user 110, and the advertising agent 115 associated with an encoded advertisement 105, that is stored within the advertisement object repository database 120.

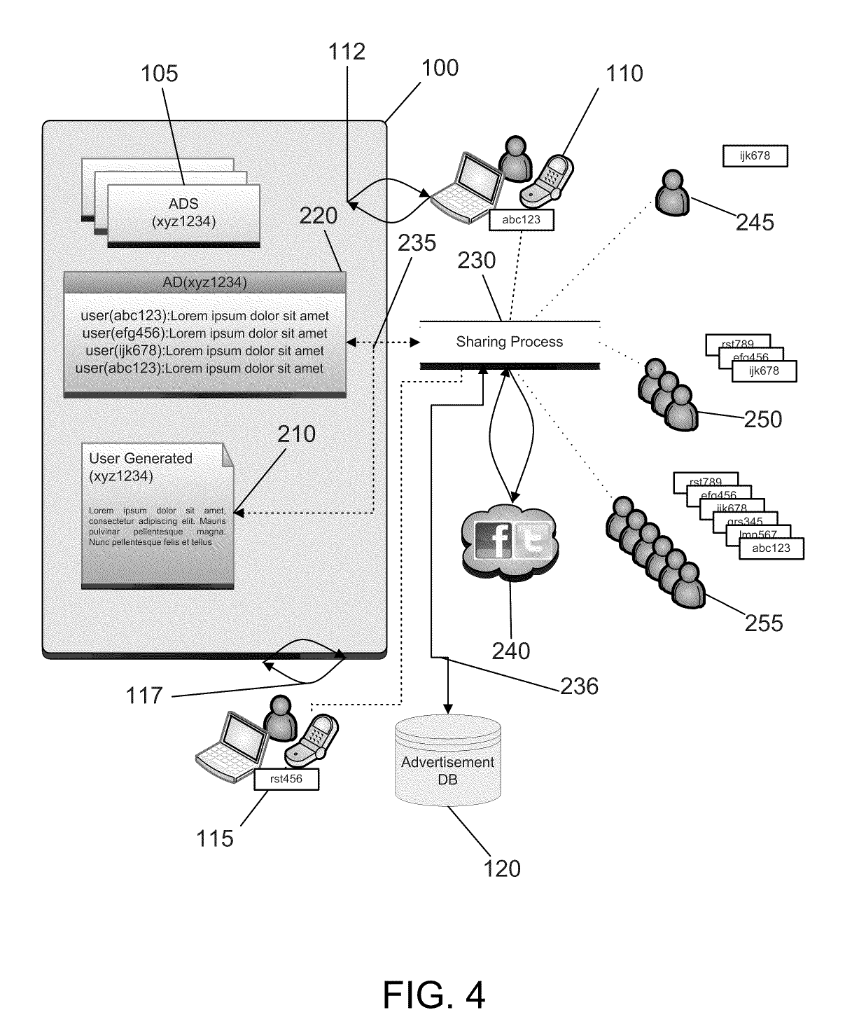

FIG. 4 illustrates one example embodiment of interaction between the encoded advertisement object 105, the advertising agent 115, the digital media user 110, and other consumers based upon a distributed advertisement(s) within the advertisement object repository 120. The interaction depicted here is an example of a user and/or an advertising agent sharing a distributed advertisement(s) to a user, group of users, everyone within the system, as well as people in existing social networks and/or the world.

The digital media user 110 and/or the advertising agent 115 views the encoded advertisement object 105 and decides that they would like to share 230 this encoded advertisement object 105 and associated content 235 with a friend and user 245, and/or with a group of friends and/or users 250 and/or possibly the world 255. The digital media user 110 and/or the advertising agent 115 may also choose to share 230 the encoded advertisement object 105 and the associated content 235 with an existing social network 240 (e.g., TWITTER, FACEBOOK, MYSPACE, ORKUT, LINKEDIN). The digital media user 110 selects the encoded advertisement object 105 by accessing the consumer interface 112 whereas the advertising agent 115 selects the encoded advertisement object 105 by accessing the advertiser interface 117, the advertising agent 115 associated with the digital media user 110 chooses with whom to share 230 the associated content 235 (that may contain the user-generated metadata 210) and/or discussion information 220 and/or the encoded advertisement object 105. Responsive to sharing the associated content 235, the encoded advertisement 105 and the recipient's delivery information (e.g., email address or a mobile phone number) is then inserted/updated 236 into the advertisement object repository database 120 and associated to the encoded advertisement 105.

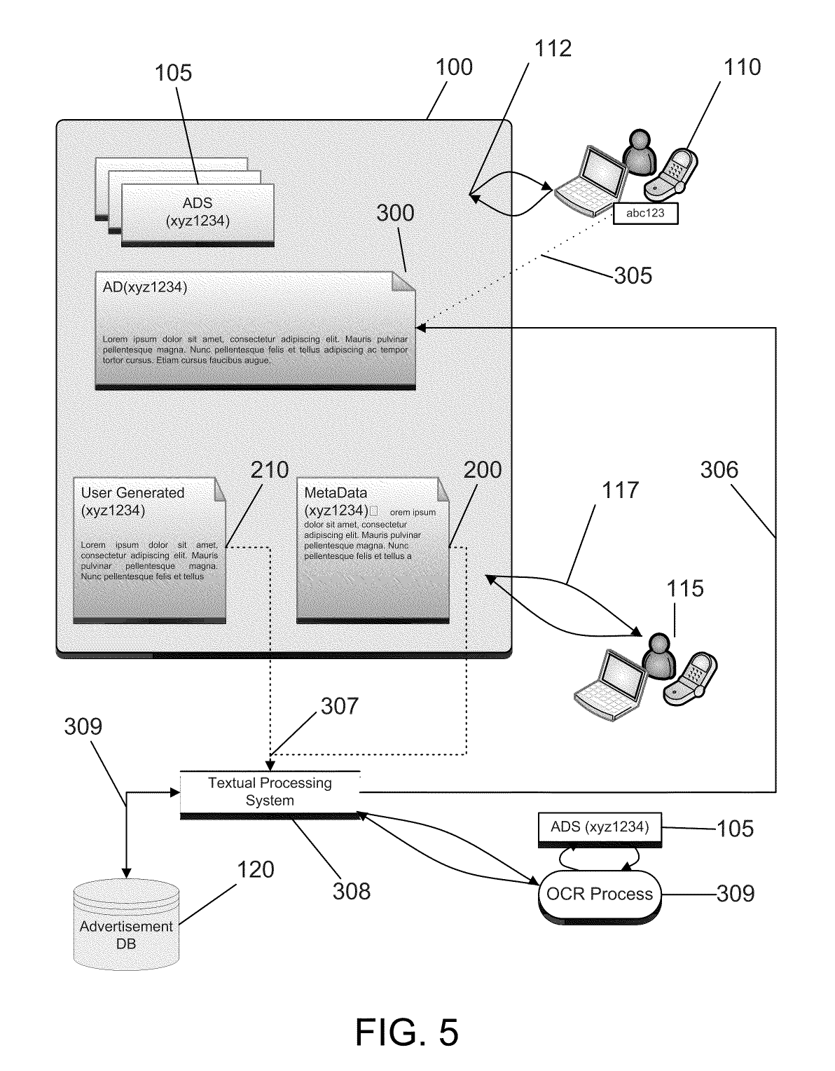

FIG. 5 illustrates one example embodiment of interaction between an encoded advertisement object 105, an advertising agent 115, and a digital media user 110 to translate and/or transform a graphical distributed advertisement into a textual representation of said distributed advertisement within an advertisement object repository 120. The interaction depicted here is an example of the system processing the distributed advertisement into a textual understanding of the distributed ad so that the user may be able to utilize the information within other systems and/or processes that would require textual information other than graphical rendering.

Advertising agent 115 selects the encoded advertisement object 105 by accessing the advertiser interface 117 and advertising agent 115 uploads and/or inserts 307 metadata 200 through the advertiser interface 117 associated with the encoded advertisement 105 within the advertising object repository 100 for processing. The metadata 200 is processed along with associated assets, and/or user-generated metadata 210 through a textual processing system 308 and into the advertisement object repository database 120. Upon interacting with the encoded advertisement 105, the advertising agent 115 has the ability to add, modify or remove additional information and/or assets 200 to for insertion into or update of 307 the advertisement object repository database 120 through the textual processing system 308 and associated with the encoded advertisement 105.

The digital media user 110 selects the encoded advertisement object 105 by accessing the consumer interface 112, views the encoded advertisement object 105 and chooses to view the textual representation 300 of the encoded advertisement object 105. The textual processing system 308 processes the request and delivers 306 to the digital media user 110 the textual representation 300 of the encoded advertisement object 105. The digital media user 110 has the ability to modify, add, and/or remove information 305 based upon user-generated metadata 210 to enhance the textual representation 300 of the advertisement object 105. The encoded advertisement 105 and the updated information is inserted into or updated within 309 the advertisement object repository database 120 and associated with the encoded advertisement 105.

The digital optical character recognition (OCR) (or similar) processor 309 translates the encoded advertisement object 105 and stores the output from the translation of the machine encoded text into the advertisement object repository database 120 and associates the translation with the encoded advertisement 105.

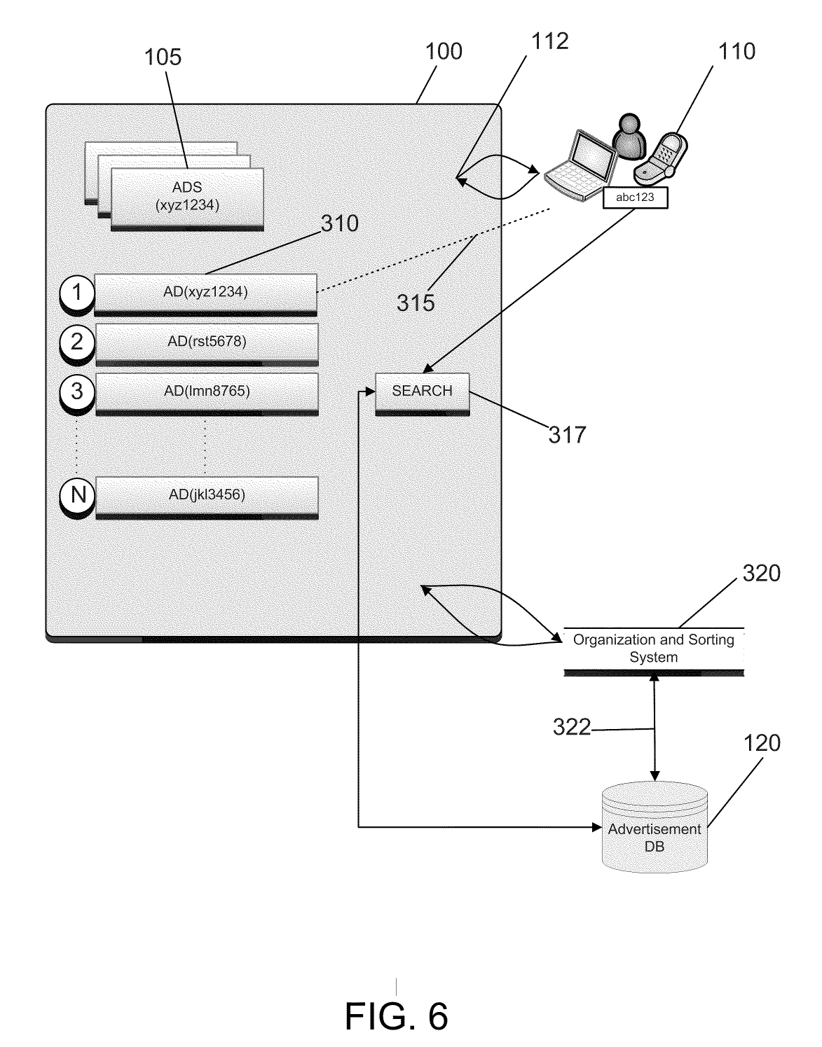

Referring now to FIG. 6, it illustrates an example embodiment of a digital media user 110 interacting with a personally controlled advertisement repository. One or more online digital advertisement objects are saved by the user 110 into a personally controlled repository. The advertisement objects are enhanced by an online advertisements management system with additional metadata. The enhanced advertisement objects can be recalled by the user for reviewing later or shared with other users who are interested. The personally controlled advertisement repository allows a user and an advertiser to maintain an ongoing presence of digital advertisement objects, which would be otherwise lost to a momentary viewing usage only in conventional online advertisements management display.

Specifically, a digital media user 110 accesses an advertisement object repository 100 through a consumer interface 112. The digital media user 110 chooses to organize and/or sort 320 advertisement display view 310. In response to a user request of changing or adding a new view 315 to the advertisement object repository 100, the online advertisements management system creates a new display 310 showing encoded advertisement objects 105. In one embodiment, the management system encodes the advertisement objects with metadata associated with the advertisement objects and/or additional information related to the advertisement objects. The digital media user 110 can view the encoded advertisement objects 105 through the consumer interface 112. The management system also saves 322 the new or changed requested view 315 into an advertisement object repository database 120 for later recall and/or use. The digital media user 110 can search 317 through the advertisement object repository database 120 to find relevant and/or associated encoded advertisement objects 105 based upon a digital media user request.

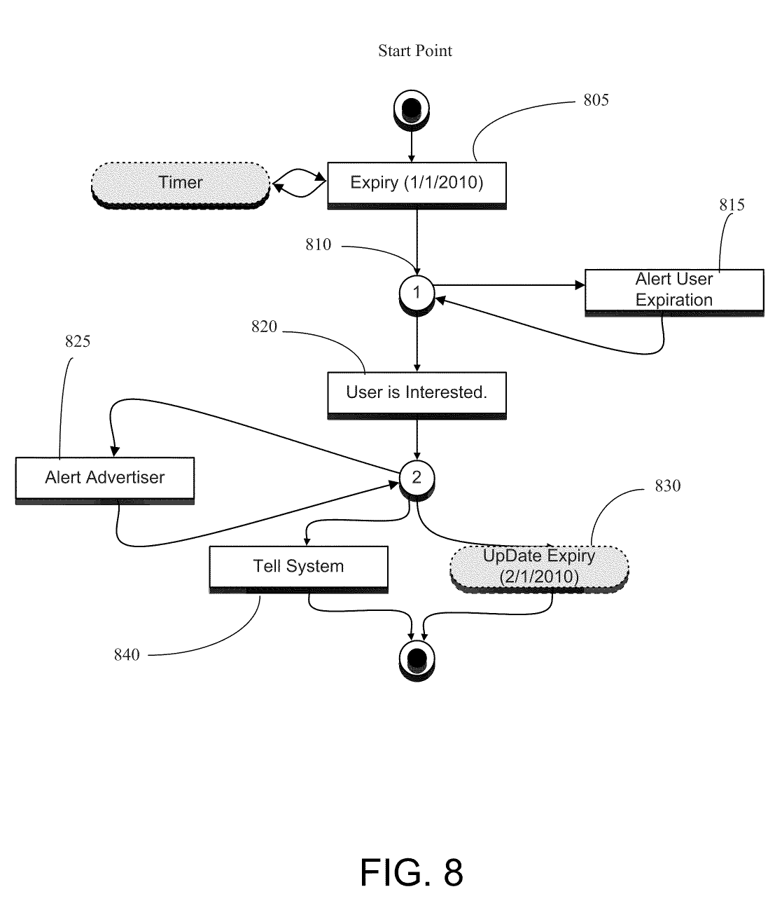

Turning next to FIG. 8, it illustrates example interactions between a digital media user and an advertiser on the expiry attribute of a distributed advertisement within an advertisement object repository according to one embodiment of the invention. Initially, an advertiser sets 805 an expiration date (e.g., Jan. 1, 2010) to an advertisement object stored in the advertisement object repository (e.g., the advertisement database 120 illustrated in FIG. 6). The advertisement object can be an advertisement previously viewed by a digital media user. Thus, the digital media user demonstrated interest in the advertisement. A timer of an online digital advertisements management system monitors 810 the time/date against the expiration date set by the advertiser and communicates the monitoring results to other entities of the communications. In response to reaching the expiration date, the timer alerts 815 the digital media user about the expiration date. The digital media user decides 820 whether to act upon the advertisement that is to be expired. Responsive to a decision to act upon the advertisement, the digital media user can alert 825 the advertiser about the decision by sending a notification to the advertiser.

Upon receiving the alert from the digital media user, the advertiser can update 830 the expiration date of the advertisement object. For example, the advertiser can extend the expiration date of the advertisement object. The advertiser can also create a new offer for the digital media user. The new offer can be related to the advertisement to be expired. The extension of the advertisement to be expired and the new offer from the advertisement provide an opportunity for the digital media user to take advantage of the new offer and afford the advertiser another opportunity to engage the digital media user. Upon the update of the expiration date of the advertisement or new offer from the advertiser, the online digital advertisements management system is reconfigured to process the update and/or the new offer using a tell system 840. In one embodiment, the tell system 840 provides a transmittal mechanism to deliver advertisement shared by multiple digital media users using the attributes of the advertisement and recipient's delivery information.

One benefit of one embodiment of the online digital advertisements management system allows digital media users to save advertisements that are interesting to the digital media users. A corresponding benefit for an advertisement provider is the advertisement provider's ability to control and manage their advertisements provided to the digital media users. At the same time, the online digital advertisements management system provides a bi-directional communication channel between the digital media users and the advertisement providers.

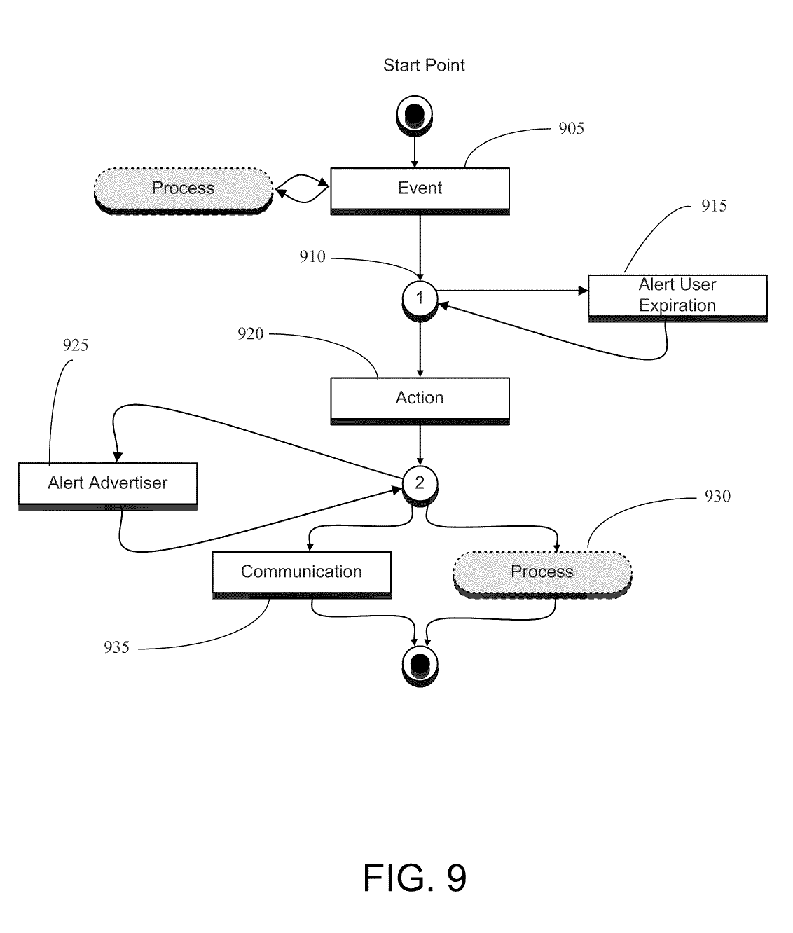

Continuing on to FIG. 9, it illustrates an example generalized communication process similar to the one described with the reference to FIG. 8 according to one embodiment. The communications process illustrates the interactions between a digital media user and an advertiser on an attribute and/or an event associated with a distributed advertisement within an advertisement object repository.

Initially, an event is triggered 905, where the event is associated with an advertisement stored in the advertisement object repository (e.g., the advertisement database 120 illustrated in FIG. 6). The event may be triggered by an action from a digital media user, such as the user clicking the advertisement. The event may also be triggered by an action from an advertiser, such as the advertiser setting an expiration date to an advertisement. The online digital advertisements management system processes 910 the event, such as creating an encoded advertisement object responsive to user clicking an advertisement. Upon finishing processing the event, the management system alerts 915 the digital media user and/or the advertiser. Responsive to the alert, the digital media user takes 920 one or more actions, such as notifying the advertiser the continuing interest in the advertisement or requesting a new view of the advertisement object repository associated with the user. The action taken by the digital media user triggers the management system to alert 925 the advertiser for the user action. The advertiser communicates with the management system to respond 935 to the user action, such as updating an attribute associated with the advertisement of interest to the digital media user or providing a new advertisement that may interest the digital media user. The management system management system is reconfigured to process 930 the actions from the advertiser and/or the digital media user.

### Computing Machine Architecture

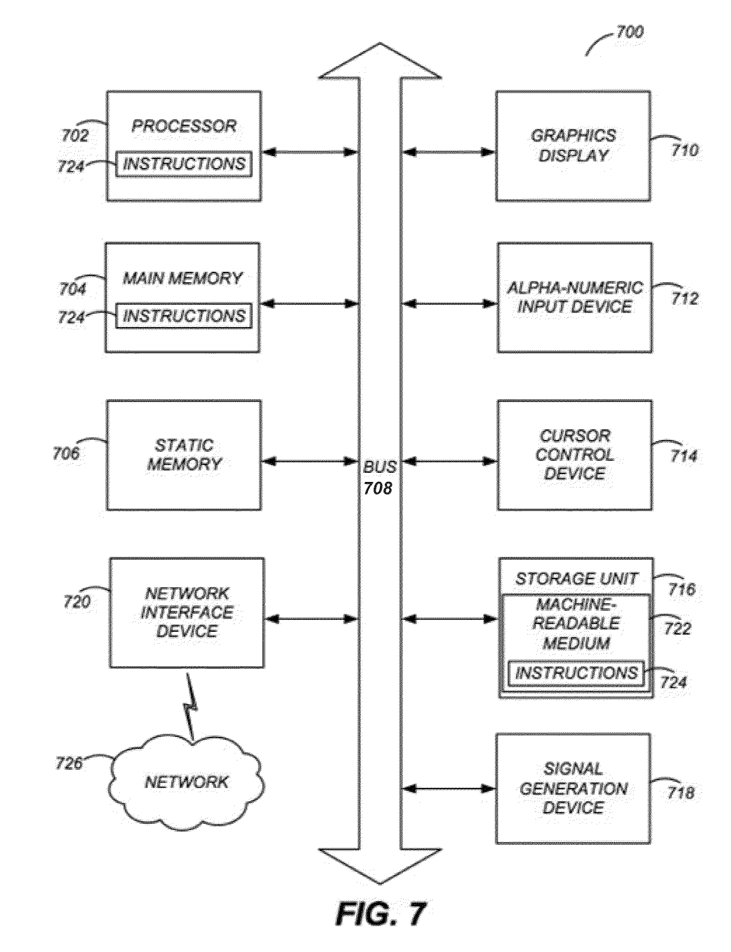

Turning now to FIG. 7, illustrated is a block diagram of one embodiment of components of an example machine that is able to read instructions from a machine-readable medium and execute such instructions in a processor (or controller). The machine architecture is configured to execute the processes described in the description corresponding to FIGS. 1, 2, 3, 4, 5, 6, 8 and 9. These processes may be embodied as instructions stored on a computer readable storage medium and executable by a processor. The example machine can correspond to the machine on which a web browser application is running (or executing). The executing web browser application is configured to allow a user to interact. The advertisement and mechanism (e.g., software switch, button, dial, etc.) is present within this configuration for a user to select in order to save and interact with the advertisement in an object as described throughout the specification. In addition, the machine corresponds to the server architecture, which saves the received advertisement as an object, retrieves and provides it for display when requested by a user, e.g., through a machine running the web browser application.

Looking more specifically at FIG. 7, the illustration shows a diagrammatic representation of a machine in the example form of a computer system 700 within which instructions 724 (e.g., software) cause the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment. The instructions 724 include instructions corresponding to carrying out the functionality of components described previously for the user side (e.g., client system) or service side (e.g., server system) operations, for example, in the accompanying figures (or drawings). These instructions are configured within the computer system 700 as further described herein, with appropriate correspondence relating to whether the computer system 700 is configured for the user (e.g., client) or the service (e.g., server) side operation.

The machine may be a server computer, a client computer, a personal computer (PC), a laptop computer, a tablet computer, a set-top box (STB), a personal digital assistant (PDA), a cellular telephone, a smart phone, a web appliance, a network router, switch or bridge, or any machine capable of executing instructions 724 (sequential or otherwise) that specify actions to be taken by that machine. Further, while only a single machine is illustrated, the term “machine” shall also be taken to include any collection of machines that individually or jointly execute instructions 724 to perform any one or more of the methodologies discussed herein.

The example computer system 700 includes a processor 702 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 704, and a static memory 706, which are configured to communicate with each other via a bus 708. The computer system 700 may further include graphics display unit 710 (e.g., a plasma display panel (PDP), a liquid crystal display (LCD), a projector, or a cathode ray tube (CRT)). The computer system 700 may also include alphanumeric input device 712 (e.g., a keyboard), a cursor control device 714 (e.g., a mouse, a trackball, a joystick, a motion sensor, or other pointing instrument), a storage unit 716, a signal generation device 718 (e.g., a speaker), and a network interface device 720, which also are configured to communicate via the bus 708.

The storage unit 716 includes a machine-readable medium 722 on which is stored instructions 724 (e.g., software) embodying any one or more of the methodologies or functions described herein, e.g., as described in the accompanying figures (or drawings). The instructions 724 (e.g., software) may also reside, completely or at least partially, within the main memory 704 or within the processor 702 (e.g., within a processor's cache memory) during execution thereof by the computer system 100, the main memory 704 and the processor 702 also constituting machine-readable media. The instructions 724 (e.g., software) may be transmitted or received over a network 726 via the network interface device 720.

While machine-readable medium 722 is shown in an example embodiment to be a single medium, the term “machine-readable medium” should be understood to include a single medium or multiple media (e.g., a centralized or distributed database, or associated caches and servers) able to store instructions (e.g., instructions 724). The term “machine-readable medium” shall also be understood to include any medium that is capable of storing instructions (e.g., instructions 724) for execution by the machine and those that cause the machine to perform any one or more of the methodologies disclosed herein. The term “machine-readable medium” includes, but is not limited to, data repositories in the form of solid-state memories, optical media, and magnetic media.

### Additional Configuration Considerations

Throughout this specification, plural instances may implement components, operations, or structures described as a single instance. Although individual operations of one or more methods are illustrated and described as separate operations, one or more of the individual operations may be performed concurrently. Nothing requires that the operations be performed in the order illustrated. Structures and functionality presented as separate components in example configurations may be implemented as a combined structure or single component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium as noted with FIG. 7 or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software as noted in FIG. 7) may be driven by cost and time considerations.

Accordingly, the term “hardware module” should be understood to encompass a tangible entity, such that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different point in time.

Hardware modules can provide information to, and receive information from, other hardware modules. Accordingly, the described hardware modules may be regarded as being communicatively coupled. Where a multiple of such hardware modules exist contemporaneously, communications may be achieved through signal transmission (e.g., over appropriate circuits and buses) that connects the hardware modules. In embodiments in which multiple hardware modules are configured or instantiated at different times, communications between such hardware modules may be achieved, (e.g., through the storage and retrieval of information in memory structures to which the multiple hardware modules have access). For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of possible methods described herein may be performed, at least partially, by one or more processors that are temporarily or permanently configured (e.g., by software) to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain operations may be distributed among the one or more processors, not only residing within a single machine, but also could be deployed across a number of machines. In some embodiment examples, the one or more processors or processor-implemented modules may be located in a single geographic location (e.g., within a home environment, an office environment, or a server farm). In other embodiment examples, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in such art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate additional alternative structural and functional designs for a system and a process for capturing and storing online content, e.g., digital advertisement objects, into a personally controlled repository (as the disclosed principles herein have described) as well as the extension, enhancement and management of such said stored content. Thus, while particular embodiments and applications have been illustrated and described, it should be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer implemented method for managing interactive online advertisements, comprising:
receiving a request for an advertisement from a user, the advertisement having a unique identification;
retrieving the requested advertisement from an advertisement objects repository, wherein an advertisement is represented by an advertisement object in the advertisement objects repository;
setting an expiration date to the requested advertisement;
monitoring the expiration date to the requested advertisement and one or more user actions related to the requested advertisement; and
encoding the requested advertisement based on the user actions.

2. The method of claim 1, wherein monitoring the expiration date to the request advertisement comprises notifying the user prior to the expiration date of the requested advertisement.

3. The method of claim 1, wherein monitoring one or more user actions related to the requested advertisement comprises notifying the advertiser of the requested advertisement responsive to one or more user actions related to the requested advertisement.

4. The method of claim 1, wherein encoding the requested advertisement comprises modifying the requested advertisement with metadata associated with the requested advertisement.

5. The method of claim 4, wherein the metadata associated with the requested advertisement comprises one of a group of information retrieved from an advertisement categorization repository, information retrieved from a taxonomy repository and information observed from user interactions with the advertisement objects repository.

6. The method of claim 1, wherein encoding the requested advertisement further comprises creating a new advertisement object based on the user actions with the advertisement objects repository.

7. The method of claim 1, wherein encoding the requested advertisement further comprises resetting the expiration date of the requested advertisement responsive to an indication that the user is interested in the requested advertisement.

8. The method of claim 1, further comprises presenting the encoded advertisement to one or more other users who are interested in the encoded advertisement.

9. A non-transitory computer-readable medium containing executable computer program code for managing interactive online advertisements, the executable computer program code comprising code for:
receiving a request for an advertisement from a user, the advertisement having a unique identification;
retrieving the requested advertisement from an advertisement objects repository, wherein an advertisement is represented by an advertisement object in the advertisement objects repository;
setting an expiration date to the requested advertisement;
monitoring the expiration date to the requested advertisement and one or more user actions related to the requested advertisement; and
encoding the requested advertisement based on the user actions.

10. The computer-readable medium of claim 9, wherein the computer program code for monitoring the expiration date to the request advertisement further comprises computer program code for notifying the user prior to the expiration date of the requested advertisement.

11. The computer-readable medium of claim 9, wherein the computer program code for monitoring one or more user actions related to the requested advertisement further comprises computer program code for notifying the advertiser of the requested advertisement responsive to one or more user actions related to the requested advertisement.

12. The computer-readable medium of claim 9, wherein the computer program code for encoding the requested advertisement further comprises computer program code for modifying the requested advertisement with metadata associated with the requested advertisement.

13. The computer-readable medium of claim 12, wherein the metadata associated with the requested advertisement comprises one of a group of information retrieved from an advertisement categorization repository, information retrieved from a taxonomy repository and information observed from user interactions with the advertisement objects repository.

14. The computer-readable medium of claim 9, wherein the computer program code for encoding the requested advertisement further comprises computer program code for creating a new advertisement object based on the user actions with the advertisement objects repository.

15. The computer-readable medium of claim 9, wherein the computer program code for encoding the requested advertisement further comprises computer program code for resetting the expiration date of the requested advertisement responsive to an indication that the user is interested in the requested advertisement.

16. The computer-readable medium of claim 9, further comprises computer program code for presenting the encoded advertisement to one or more other users who are interested in the encoded advertisement.

17. A system for managing interactive online advertisements, the system comprising:
a computer processor; and
an advertising agent, coupled to the computer processor, configured to:
receive a request for an advertisement from a user, the advertisement having a unique identification;
retrieve the requested advertisement from an advertisement objects repository, wherein an advertisement is represented by an advertisement object in the advertisement objects repository;
set an expiration date to the requested advertisement;
monitor the expiration date to the requested advertisement and one or more user actions related to the requested advertisement; and
encode the requested advertisement based on the user actions.

18. The system of claim 17, wherein the advertising agent is further configured to notify the user prior to the expiration date of the requested advertisement.

19. The system of claim 17, wherein the advertising agent is further configured to notify the advertiser of the requested advertisement responsive to one or more user actions related to the requested advertisement.

20. The system of claim 17, wherein the advertising agent is further configured to modify the requested advertisement with metadata associated with the requested advertisement.

21. The system of claim 17, wherein the metadata associated with the requested advertisement comprises one of a group of information retrieved from an advertisement categorization repository, information retrieved from a taxonomy repository and information observed from user interactions with the advertisement objects repository.

22. The system of claim 17, wherein the advertising agent is further configured to create a new advertisement object based on the user actions with the advertisement objects repository.

23. The system of claim 17, wherein the advertising agent is further configured to reset the expiration date of the requested advertisement responsive to an indication that the user is interested in the requested advertisement.

24. The system of claim 17, further an advertiser interface configured to present the encoded advertisement to one or more other users who are interested in the encoded advertisement.
